(19) United States
(12) Patent Application Publication
(10) Pub. No.: US 2015/0161401 A1
(43) Pub. Date: Jun. 11, 2015

(54) PROCESSOR HAVING A VARIABLE PIPELINE, AND SYSTEM-ON-CHIP

(71) Applicant: Samsung Electronics Co., Ltd., Suwon-Si (KR)

(72) Inventors: Ji-Myung NA, Suwon-si (KR); Ki-Hong KIM, Osan-si (KR); Sang-Bum KIM, Yongin-si (KR); Jung-Hyun KIM, Seoul (KR)

(21) Appl. No.: 14/533,810

(22) Filed: Nov. 5, 2014

Related U.S. Application Data
(60) Provisional application No. 61/914,021, filed on Dec. 10, 2013.

(30) Foreign Application Priority Data
Jan. 13, 2014 (KR) 10-2014-0003933

(51) Int. Cl. G06F 21/60; G06F 1/06

(52) U.S. Cl. CPC G06F 21/602; G06F 1/06

(57) ABSTRACT

A processor includes a security level determining unit and a variable pipeline. The security level determining unit determines a security level of first data to be processed by the processor. The variable pipeline receives the first data, generates original data by performing a decryption operation on the first data during a total number of one or more clock cycles corresponding to the security level determined by the security level determining unit, and processes the original data.

### CROSS-REFERENCE TO RELATED APPLICATIONS

This U.S. non-provisional application claims the benefit of priority under 35 U.S.C. §119 to U.S. Provisional Application No. 61/914,021 filed on Dec. 10, 2013 in the USPTO, and Korean Patent Application No. 10-2014-0003933 filed on Jan. 13, 2014 in the Korean Intellectual Property Office (KIPO), the entire contents of each of which are incorporated by reference herein in their entireties.

### BACKGROUND

1. Technical Field

At least some example embodiments of the inventive concepts relate generally to processors and, more particularly, to processors having pipelines and system-on-chips including the processors.

2. Description of the Related Art

In a security product, such as a smart card, a trusted platform module (TPM), etc., instructions and/or data are encrypted before being stored. To execute the encrypted instructions and/or data by a processor, an encryption unit located outside of the processor decrypts the encrypted instructions and/or data to provide the processor with original instructions and/or data. To reduce or, alternatively, minimize the deterioration of the operating performance (or an operating speed) of a system, it may be desirable for the encryption unit located outside of the processor to perform a simple encryption/decryption operation within one clock cycle. However, as a hacking (or tampering) technique has advanced, original instructions and/or data can be more readily extracted from the instructions and/or data encrypted by the simple encryption operation by a hacker (or an attacker). Further, in a case where the encryption unit located outside of the processor performs an encryption/decryption operation during more than one clock cycle to prevent the data leakage, the operating performance may be greatly deteriorated.

### SUMMARY

Some at least some example embodiments of the inventive concepts provide a processor having a variable pipeline.

Some at least some example embodiments of the inventive concepts provide a system-on-chip including the processor.

According to at least some example embodiments of the inventive concepts, a processor includes a security level determining unit configured to determine a security level of first data to be processed by the processor; and a variable pipeline configured to receive the first data, to generate original data by performing a decryption operation on the first data during a total number of one or more clock cycles corresponding to the security level determined by the security level determining unit, and to process the original data.

The variable pipeline may include a variable decryption block configured to adjust an operation time of the decryption operation according to the security level of the first data.

The processor may be configured such that the variable decryption block, does not perform the decryption operation when the security level of the first data is a low security level, performs the decryption operation during one clock cycle when the security level of the first data is a normal security level, and performs the decryption operation during two or more clock cycles when the security level of the first data is a high security level.

The variable pipeline may include a variable decryption block configured to generate the original data by decrypting the first data during the one or more clock cycles corresponding to the security level; a fetch block configured to store the original data in a register; a decode block configured to decode the original data; and an execute block configured to execute the decoded original data.

The variable pipeline may include a fetch block configured to store the first data in a register; a variable decryption block configured to generate the original data by decrypting the first data that are stored in the register during the one or more clock cycles corresponding to the security level; a decode block configured to decode the original data; and an execute block configured to execute the decoded original data.

The variable pipeline may include a plurality of decryption blocks that are connected in series; and a plurality of switches disposed at input terminals of the plurality of decryption blocks, respectively, each switch configured to selectively connect a data path to a corresponding one of the plurality of decryption blocks or to a next stage block, the next stage block being a block of the variable pipeline that follows the plurality of variable decryption blocks.

Among the plurality of switches, each of a number of switches corresponding to the total number of one or more clock cycles that is determined according to the security level of the first data may connect the data path to the corresponding one of the plurality of decryption blocks, and remaining ones of the switches connect the data path to the next stage block.

The variable pipeline may include a plurality of decryption blocks configured to respectively perform decryption operations during different operation times, the different operation times having differing durations; and a switch configured to connect a data path to a decryption block having one of the different operation times corresponding to the clock cycle that is determined according to the security level of the first data among the plurality of decryption blocks.

The variable pipeline may include a plurality of decryption blocks configured to respectively perform decryption operations with different decryption algorithms; and a switch configured to connect a data path to a decryption block having a first decryption algorithm from among the plurality of decryption blocks, the first decryption algorithm being a decryption algorithm that corresponds to the security level of the first data from among the different decryption algorithms.

The processor may be configured such that the variable pipeline encrypts a result of processing the original data during the clock cycle corresponding to the security level, and outputs the encrypted result.

The variable pipeline may include a variable encryption block configured to adjust an operation time of an encryption operation according to the security level of the first data.

The security level determining unit may include a security policy storing unit configured to store an address range for the first data, and a number of clock cycles corresponding to the address range; and a pipeline control unit configured to receive an address of the first data to be processed by the processor, to read the number of clock cycles corresponding to the address range to which the received address belongs from the security policy storing unit, and to control the variable pipeline to perform the decryption operation during an operation time corresponding to the read number of clock cycles.

The processor may be configured such that, the security level determining unit further stores an encryption key corresponding to the address range, and the pipeline control unit controls the variable pipeline to perform the decryption operation using the encryption key corresponding to the address range to which the received address belongs.

The processor may be configured such that, the security level determining unit further stores a type of a decryption algorithm corresponding to the address range, and the pipeline control unit controls the variable pipeline to perform the decryption operation with the decryption algorithm corresponding to the address range to which the received address belongs.

According to at least some example embodiments of the inventive concepts, a system-on-chip includes a memory unit configured to store first data; and a processor configured to, receive the first data from the memory unit, to determine a security level of the first data, generate original data by performing a decryption operation on the first data during a clock cycle corresponding to the determined security level, and process the original data.

According to at least some example embodiments of the inventive concepts, a processor, includes a security level determining unit configured to determine a security level of first data; and a variable pipeline configured to, receive the first data, generate original data by performing a decryption operation on the first data, and process the original data, the processor being configured to select the duration of the decryption operation based on the determined security level.

The security level determined by the security level determining unit may be selected from among a plurality of different security levels, the plurality of security levels including a lowest security level and a plurality of upper security levels, the processor may be configured such that the duration selected by the processor is one or more clock cycles when the determined security level is one of the higher security levels, and the processor may be configured such that the variable pipeline does not perform the decryption operation when the determined security level is the lowest security level.

The processor may be configured such that, when the determined security level is one of the plurality of upper security levels, a total number of the clock cycles in the duration selected by the processor increases as the determined security level becomes higher, and the total number of the clock cycles in the duration selected by the processor decreases as the determined security level becomes lower.

The plurality of upper security levels may each correspond to one of a plurality of different decryption algorithms, the plurality of upper security levels may include at least first and second security levels, the plurality of different decryption algorithms includes at least first and second decryption algorithms, and the first and second security levels correspond to the first and second decryption algorithms, respectively, and when the determined security level is one of the plurality of upper security levels, the variable pipeline may be configured to perform the decryption operation using a selected decryption algorithm, the selected decryption algorithm being the decryption algorithm, from among the plurality of algorithms, that corresponds to the determined security level.

### BRIEF DESCRIPTION OF THE DRAWINGS

The above and other features and advantages of at least some example embodiments of the inventive concepts will become more apparent by describing in detail at least some example embodiments of the inventive concepts with reference to the attached drawings. The accompanying drawings are intended to depict at least some example embodiments of the inventive concepts and should not be interpreted to limit the intended scope of the claims. The accompanying drawings are not to be considered as drawn to scale unless explicitly noted.

FIG. 1 is a block diagram illustrating a processor according to at least some example embodiments of the inventive concepts.

FIG. 2 is a block diagram illustrating a processor according to at least some example embodiments of the inventive concepts.

FIG. 3 is a timing diagram illustrating execution cycles of a processor of FIG. 2.

FIG. 4 is a block diagram illustrating a processor according to at least some example embodiments of the inventive concepts.

FIG. 5 is a timing diagram illustrating execution cycles of a processor of FIG. 4.

FIG. 6 is a block diagram illustrating a processor according to at least some example embodiments of the inventive concepts.

FIG. 7 is a block diagram illustrating a processor according to at least some example embodiments of the inventive concepts.

FIG. 8 is a block diagram illustrating a processor according to at least some example embodiments of the inventive concepts.

FIG. 9 is a block diagram illustrating a processor according to at least some example embodiments of the inventive concepts.

FIG. 10 is a timing diagram illustrating execution cycles of a processor of FIG. 9.

FIG. 11 is a block diagram illustrating a system-on-chip according to at least some example embodiments of the inventive concepts.

FIGS. 12 and 13 are diagrams illustrating an example where a system-on-chip according to at least some example embodiments of the inventive concepts is employed in a smart card.

FIG. 14 is a diagram illustrating an example where a system-on-chip according to at least some example embodiments of the inventive concepts is employed in a trusted platform module (TPM).

FIG. 15 is a diagram illustrating an example where a system-on-chip according to at least some example embodiments of the inventive concepts is employed in an application processor (AP).

### DETAILED DESCRIPTION OF EXAMPLE EMBODIMENTS

Detailed at least some example embodiments of the inventive concepts are disclosed herein. However, specific structural and functional details disclosed herein are merely representative for purposes of describing at least some example embodiments of the inventive concepts. At least some example embodiments of the inventive concepts may, however, be embodied in many alternate forms and should not be construed as limited to only the embodiments set forth herein.

Accordingly, while at least some example embodiments of the inventive concepts are capable of various modifications and alternative forms, embodiments thereof are shown by way of example in the drawings and will herein be described in detail. It should be understood, however, that there is no intent to limit at least some example embodiments of the inventive concepts to the particular forms disclosed, but to the contrary, at least some example embodiments of the inventive concepts are to cover all modifications, equivalents, and alternatives falling within the scope of at least some example embodiments of the inventive concepts. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of at least some example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of at least some example embodiments of the inventive concepts. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

At least some example embodiments of the inventive concepts are described herein with reference to cross-sectional illustrations that are schematic illustrations of idealized at least some example embodiments of the inventive concepts (and intermediate structures). As such, variations from the shapes of the illustrations as a result, for example, of manufacturing techniques and/or tolerances, are to be expected. Thus, at least some example embodiments of the inventive concepts should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

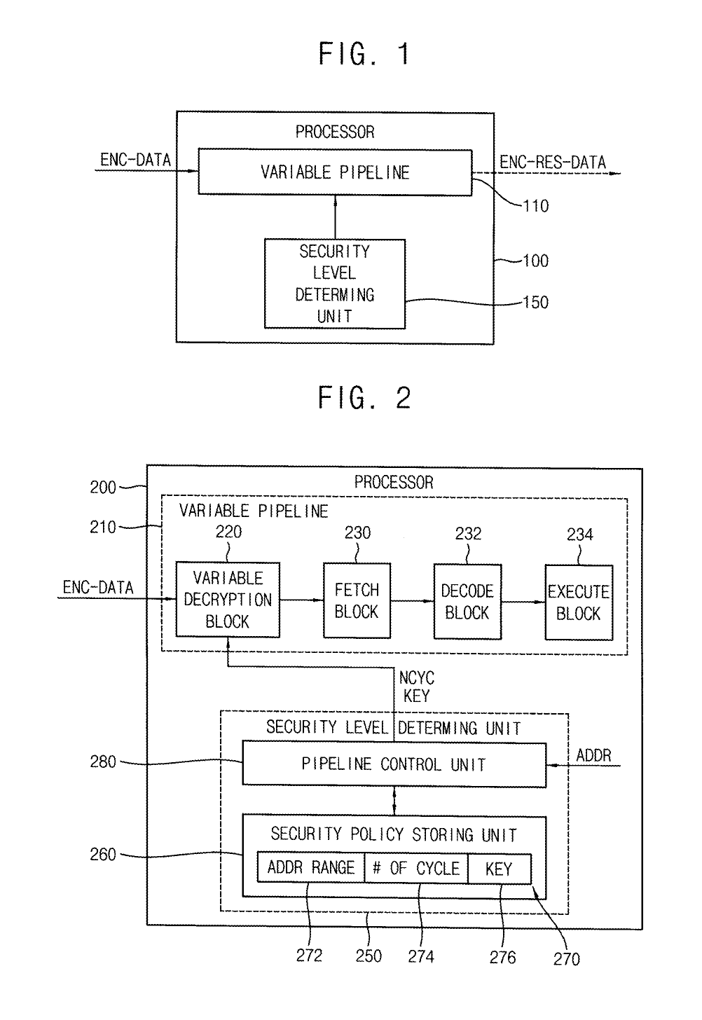

FIG. 1 is a block diagram illustrating a processor according to at least some example embodiments of the inventive concepts.

According to at least some example embodiments of the inventive concepts, the term ‘processor’, as used herein, may refer to, for example, a hardware-implemented data processing device having circuitry that is physically structured to execute code and/or instructions included, for example, in a program. Examples of the above-referenced hardware-implemented data processing device include, but are not limited to, a microprocessor, a central processing unit (CPU), a processor core, a multiprocessor, an application-specific integrated circuit (ASIC), and a field programmable gate array (FPGA).

Referring to FIG. 1, a processor 100 includes a variable pipeline 110 and a security level determining unit 150. The variable pipeline 110 and security level determining unit 150 may be implemented, for example, by one or more circuits included in the processor 100.

The security level determining unit 150 determines a security level of encrypted data ENC-DATA to be processed by the processor 100. Here, the encrypted data ENC-DATA may be encrypted program data (an encrypted instruction, an encrypted program code, or the like) to be executed by the processor 100, or may be encrypted normal data that are used, modified or generated by the program data. The security level determining unit 150 may determine the security level of the encrypted data ENC-DATA according to a location of the encrypted data ENC-DATA stored in an external memory. For example, at least one security level that is set for at least one predetermined address range of the external memory, and, in a case where the encrypted data ENC-DATA input to the processor 100 has an address belonging to the predetermined address range, the security level determining unit 150 may determine the security level of the encrypted data ENC-DATA as the stored security level.

The variable pipeline 110 receives the encrypted data ENC-DATA, and generates original data by performing a decryption operation on the encrypted data ENC-DATA. Since the decryption operation for the encrypted data ENC-DATA is performed inside the processor 100, or is performed by the variable pipeline 110, the data may have an encrypted state at the outside the processor 100, and the original data may not be exposed to the outside.

Further, the variable pipeline 110 may generate the original data by performing the decryption operation on the encrypted data ENC-DATA during a number of clock cycles corresponding to the security level determined by the security level determining unit 150 (e.g., 0, 1, 2, or n clock cycles). Each unit of encrypted data ENC-DATA may have one of a plurality of security levels, and the variable pipeline 110 may perform the decryption operations during different numbers of clock cycles with respect to the encrypted data ENC-DATA having different security levels. For example, each unit of encrypted data ENC-DATA may have one of three security levels. The variable pipeline 110 may not perform the decryption operation when the security level of the encrypted data ENC-DATA is a low security level, may perform the decryption operation during one clock cycle when the security level of the encrypted data ENC-DATA is a normal security level, and may perform the decryption operation during two or more clock cycles when the security level of the encrypted data ENC-DATA is a high security level. As described above, an operation time of the decryption operation may be changed according to the security level of the encrypted data ENC-DATA to be processed, and thus the number of execution clock cycles of the variable pipeline 110 may be changed. Though only three security levels are described in the present example, according to at least some example embodiments, there may be more than 3 security levels. Accordingly, a decryption/encryption operation of a decryption/encryption algorithm that is suitable for a security level for each unit of data can be performed.

To perform the decryption/encryption operation suitable for the security level for each unit of data, in at least some example embodiments of the inventive concepts, the variable pipeline 110 include a variable decryption block that adjusts an operation time of the decryption operation according to the security level of the encrypted data ENC-DATA. In other at least some example embodiments of the inventive concepts, the variable pipeline 110 may include a plurality of decryption blocks that are connected in series, and may allow the encrypted data ENC-DATA to be processed (or decrypted) by the number of the decryption blocks corresponding to the clock cycle determined according to the security level of the encrypted data ENC-DATA. In still other at least some example embodiments of the inventive concepts, the variable pipeline 110 may include a plurality of decryption blocks having different operation times, and may allow the encrypted data ENC-DATA to be processed by one of the decryption blocks having the operation time corresponding to the clock cycle determined according to the security level of the encrypted data ENC-DATA. The decryption blocks having different operation times may perform the decryption operations with the same decryption algorithm, or with different decryption algorithms.

The variable pipeline 110 may process the original data. For example, the variable pipeline 110 may process the original data by performing a fetch operation, a decode operation and an execute operation on the original data. In other examples, to process the original data, the variable pipeline 110 may perform the fetch operation, the decode operation, the execute operation, a buffer/data operation, and a write-back operation.

In at least some example embodiments of the inventive concepts, if, for example, a result of processing the original data is to be stored in an external memory, the variable pipeline 110 may encrypt the result of processing the original data during the number of clock cycles corresponding to the security level (e.g., 0, 1, 2, or n clock cycles), and may output encrypted result data ENC-RES-DATA. For example, the variable pipeline 110 may not perform the encryption operation when the security level is the low security level, may perform the encryption operation during one clock cycle when the security level is the normal security level, and may perform the encryption operation during two or more clock cycles when the security level is the high security level. To perform the encryption/decryption operation suitable for the security level of each data, in at least some example embodiments of the inventive concepts, the variable pipeline 110 may include a variable encryption block that adjusts an operation time of the encryption operation according to the security level. As described above, the operation time of the encryption/decryption operation may be changed according to the security level of the encrypted data ENC-DATA to be processed, or the security level of the encrypted result data ENC-RES-DATA, and thus the number of execution clock cycles of the variable pipeline 110 may be changed. Accordingly, the encryption/decryption operation of the encryption/decryption algorithm that is suitable for the security level for each data can be performed.

The processor 100 according to at least some example embodiments of the inventive concepts may perform data processing including the data encryption/decryption by using the variable pipeline 110. That is, the encryption/decryption operation as well as the fetch operation, the decode operation and the execute operation may be performed in a pipelined manner. Accordingly, when encryption/decryption operations having a strong encryption/decryption algorithm of one or more clock cycles are performed on data to be sequentially processed, although a time delay may occur with respect to initially processed data, there may be little or no time delay and/or operating performance degradation (or operating speed degradation) resulting from the encryption/decryption with respect to subsequently processed data. That is, the processor 100 according to at least some example embodiments of the inventive concepts may perform the strong encryption/decryption operation almost without the operating performance degradation.

As described above, since the processor 100 may perform the encryption/decryption operation at the inside of the processor 100, or at the variable pipeline 110, the original data may not be exposed outside of the processor 100, and may be securely protected. Further, the processor 100 according to at least some example embodiments of the inventive concepts may perform the encryption/decryption operation as well as the fetch operation, the decode operation and the execute operation in the pipelined manner, thereby reducing or preventing the operating performance degradation of the processor 100 associated with the encryption/decryption and the system including the processor 100. In addition, the processor 100 according to at least some example embodiments of the inventive concepts may include the variable pipeline 110 that adjusts the operation time of the encryption/decryption operation according to the security level of the data to be processed. Accordingly, the encryption/decryption operation having the strong encryption/decryption algorithm can be performed with respect to data that require the security of the high level, and data that require the security of the low level can be rapidly processed.

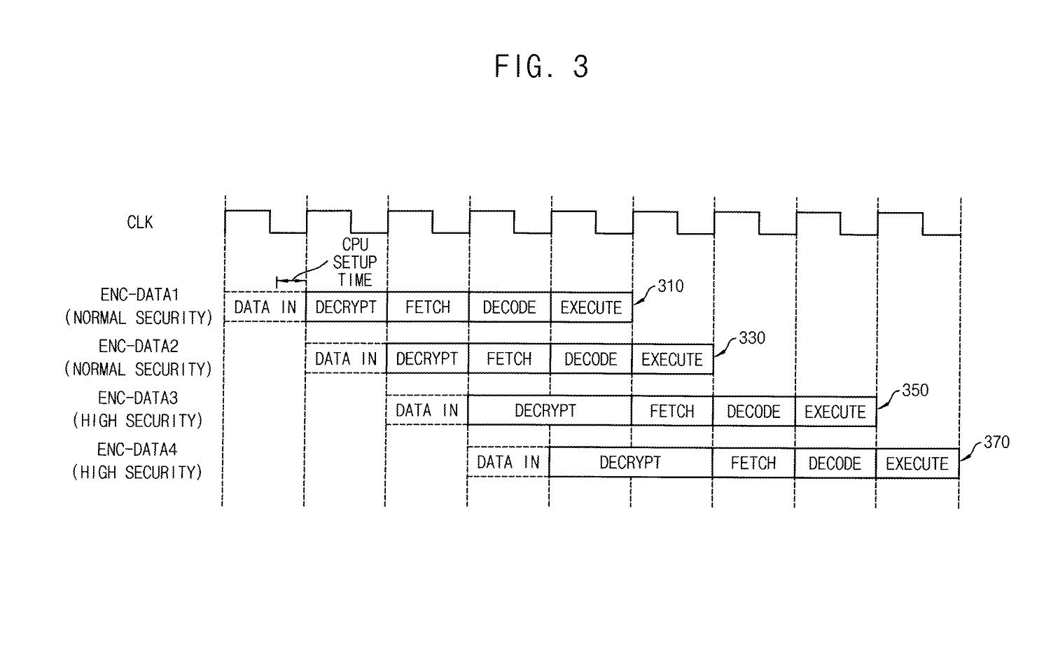

FIG. 2 is a block diagram illustrating a processor according to at least some example embodiments of the inventive concepts, and FIG. 3 is a timing diagram illustrating execution cycles of a processor of FIG. 2.

Referring to FIG. 2, a processor 200 includes a variable pipeline 210 and a security level determining unit 250. The variable pipeline 210 and security level determining unit 250 may be implemented, for example, by one or more circuits included in the processor 200.

The security level determining unit 250 may determine a security level of encrypted data ENC-DATA to be processed by the processor 200. The security level determining unit 250 may store a security policy for the encrypted data ENC-DATA, may determine the security level of the encrypted data ENC-DATA based on the stored security policy, and may control the variable pipeline 210 based on the determined security level. In at least some example embodiments of the inventive concepts, the security level determining unit 250 may include a security policy storing unit 260 that stores the security policy for the encrypted data ENC-DATA, and a pipeline control unit 280 that controls the variable pipeline 210 based on the stored security policy.

At least one security policy record 270 for the encrypted data ENC-DATA may be stored in the security policy storing unit 260. For example, the security policy record 270 may include an address range 272 of an external memory, the number of clock cycles 274 of an encryption/decryption operation to be performed on the encrypted data ENC-DATA stored within the address range 272, and an encryption key (or a cryptographic key) 276 used in the encryption/decryption operation to be performed on the encrypted data ENC-DATA stored within the address range 272. In at least some example embodiments of the inventive concepts, when a desired or, alternatively, predetermined application or program is loaded into the external memory to be executed, the security policy record 270 for the application or program may be written into the security policy storing unit 260.

The pipeline control unit 280 may receive an address ADDR of the encrypted data ENC-DATA to be processed by the processor 200. For example, the pipeline control unit 280 may receive the address ADDR of the encrypted data ENC-DATA input to the variable pipeline 210 from a desired or, alternatively, predetermined register included in the processor 200, such as a program counter (PC), an instruction pointer (IP), an instruction register (IR), etc.

The pipeline control unit 280 may search the security policy storing unit 260 for the security policy record 270 including the address range 272 to which the received address ADDR belongs, and may read the number of clock cycles 274 included in the searched security policy record 270 from the security policy storing unit 260. The pipeline control unit 280 may control the variable pipeline 210 to perform a decryption operation during an operation time corresponding to the number of clock cycles 274 by providing a cycle number signal NCYC representing the number of clock cycles 274 to the variable pipeline 210. Further, the pipeline control unit 280 may further read the encryption key 276 included in the searched security policy record 270 from the security policy storing unit 260. The pipeline control unit 280 may control the variable pipeline 210 to perform the decryption operation using the encryption key 276 by providing the encryption key 276 to the variable pipeline 210.

The variable pipeline 210 may receive the encrypted data ENC-DATA, may generate original data by performing the decryption operation on the encrypted data ENC-DATA during the number of clock cycles corresponding to the security level determined by the security level determining unit 250 (e.g., 0, 1, 2, or n clock cycles), and may process the original data. In at least some example embodiments of the inventive concepts, the variable pipeline 210 may include a variable decryption block 220, a fetch block 230, a decode block 232 and an execute block 234.

The variable decryption block 220 may generate the original data by decrypting the encrypted data ENC-DATA input to the processor 200 during the number of clock cycles corresponding to the security level (e.g., 0, 1, 2, or n clock cycles). That is, the variable decryption block 220 may adjust an operation time of the decryption operation according to the security level of the encrypted data ENC-DATA. In at least some example embodiments of the inventive concepts, the pipeline control unit 280 may provide the variable decryption block 220 with the cycle number signal NCYC representing the number of clock cycles 274 corresponding to the security level of the encrypted data ENC-DATA (e.g., 0, 1, 2, or n clock cycles), and the variable decryption block 220 may perform the decryption operation during the number of clock cycles 274 indicated by the cycle number signal NCYC. For example, when the security level of the encrypted data ENC-DATA is a low security level, the cycle number signal NCYC may indicate zero clock cycle, and the variable decryption block 220 may not perform the decryption operation. When the security level of the encrypted data ENC-DATA is a normal security level, the cycle number signal NCYC may indicate one clock cycle, and the variable decryption block 220 may perform the decryption operation during an operation time of one clock cycle. Further, when the security level of the encrypted data ENC-DATA is a high security level, the cycle number signal NCYC may indicate two clock cycles, and the variable decryption block 220 may perform the decryption operation during an operation time of two clock cycles. The variable decryption block 220 may further receive the encryption key KEY from the pipeline control unit 280, and may perform the decryption operation using the received encryption key KEY. As described above, since the decryption operation is performed inside the processor 200, or is performed by the variable decryption block 220, the original data may not be exposed outside of the processor 200, and may be securely protected.

The fetch block 230 may store the original data generated by the variable decryption block 220 in a register included in the processor 200. For example, the fetch block 230 may store the original data in an instruction register (IR). The decode block 232 may decode the original data. For example, the decode block 232 may decode the original data stored in the instruction register to find out an operation to be performed by the execute block 234. The execute block 234 may execute the decoded original data.

The variable pipeline 210 may process in parallel the encrypted data ENC-DATA in a pipelined manner. FIG. 3 illustrates an example of the pipelined processing of the variable pipeline 210. In FIG. 3, 310 represents an execution timing of first encrypted data ENC-DATA1 having a normal security level, 330 represents an execution timing of second encrypted data ENC-DATA2 having the normal security level, 350 represents an execution timing of third encrypted data ENC-DATA3 having a high security level, and 370 represents an execution timing of fourth encrypted data ENC-DATA4 having the high security level.

As illustrated in FIG. 3, at a first clock cycle, the first encrypted data ENC-DATA1 may be input to the processor 200. To ensure that data is properly input to the processor 200, levels of signals representing the data (e.g., the first encrypted data ENC-DATA1) may reach the processor 200 and be maintained throughout a desired or, alternatively, predetermined setup time (e.g., a CPU setup time) before a time point at which processing the data is initiated. At a second clock cycle, while a decryption operation is performed on the first encrypted data ENC-DATA1, the second encrypted data ENC-DATA2 may be input to the processor 200. At a third clock cycle, a fetch operation for the first encrypted data ENC-DATA1 (or original data of the first encrypted data ENC-DATA1), a decryption operation for the second encrypted data ENC-DATA2, and an input of the third encrypted data ENC-DATA3 may be simultaneously performed. Further, at a fourth clock cycle, a decode operation for the first encrypted data ENC-DATA1 (or original data of the first encrypted data ENC-DATA1), a fetch operation for the second encrypted data ENC-DATA2 (or original data of the second encrypted data ENC-DATA2), a decryption operation for the third encrypted data ENC-DATA3, and an input of the fourth encrypted data ENC-DATA4 may be simultaneously performed. In this manner, respective stages of the variable pipeline 210, or the variable decryption block 220, the fetch block 230, the decode block 232 and the execute block 234 may process different data ENC-DATA1, ENC-DATA2, ENC-DATA3 and ENC-DATA4 in parallel, thereby improving the operating performance of the processor 200 and the system including the processor 200.

Compared with a case where the encryption/decryption operation is not performed, a processing time of the initially processed data ENC-DATA1 of the sequentially processed data ENC-DATA1, ENC-DATA2, ENC-DATA3 and ENC-DATA4 may be delayed by one clock cycle. Further, when an operation time of the decryption operation is increased (e.g., when the third encrypted data ENC-DATA3 is processed), the processing time may be increased. However, since the encryption/decryption operation as well as the fetch operation, the decode operation and the execute operation are performed in a pipelined manner, little or no delay may occur with respect to subsequent processes. Accordingly, a delay of the entire processing time of the sequentially processed data ENC-DATA1, ENC-DATA2, ENC-DATA3 and ENC-DATA4 may not be critical.

Further, as illustrated in FIG. 3, the decryption operation for the encrypted data ENC-DATA1 and ENC-DATA2 having the normal security level may be performed during one clock cycle, and the decryption operation for the encrypted data ENC-DATA3 and ENC-DATA4 having the high security level may be performed during two or more clock cycles. Thus, the operation time of the encryption/decryption operation may be adjusted according to the security level of the data. Accordingly, the encryption/decryption operation of the encryption/decryption algorithm that is suitable for the security level for each data can be performed.

As described above, since the processor 200 may perform the encryption/decryption operation at the inside of the processor 200, or at the variable decryption block 220, the original data may not be exposed outside of the processor 200, and may be securely protected. Further, the processor 200 according to at least some example embodiments of the inventive concepts may perform the encryption/decryption operation as well as the fetch operation, the decode operation and the execute operation in the pipelined manner, thereby reducing or preventing the operating performance degradation of the processor 200 and the system including the processor 200 associated with the encryption/decryption. In addition, the processor 200 according to at least some example embodiments of the inventive concepts may include the variable pipeline 210 that adjusts the operation time of the encryption/decryption operation according to the security level of the data to be processed. Accordingly, an encryption/decryption operation having relatively strong encryption/decryption algorithm can be performed with respect to data that require the security of the high level, and data that require the security of the low level can be rapidly processed with a less strong encryption/decryption algorithm or, alternatively, no decryption/encryption.

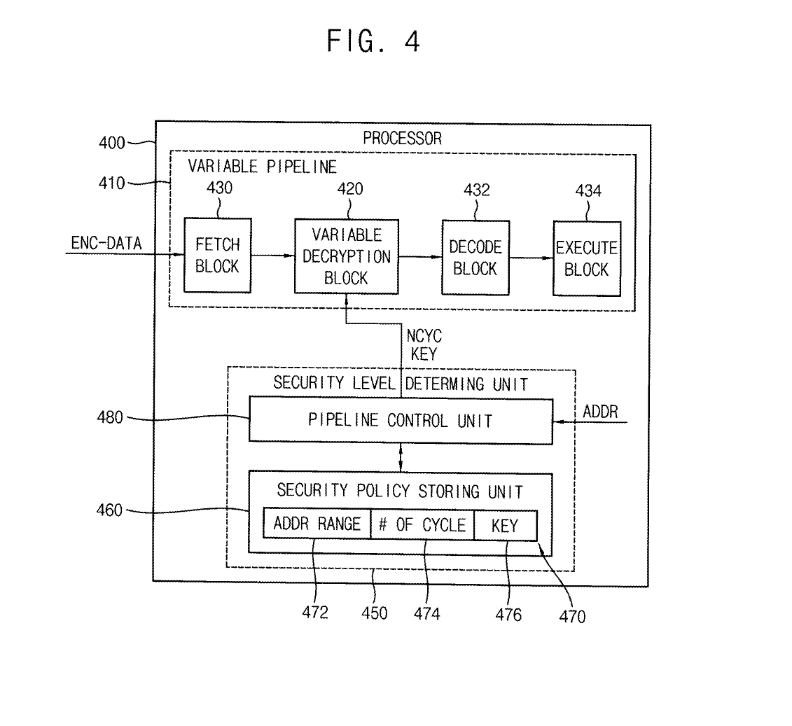

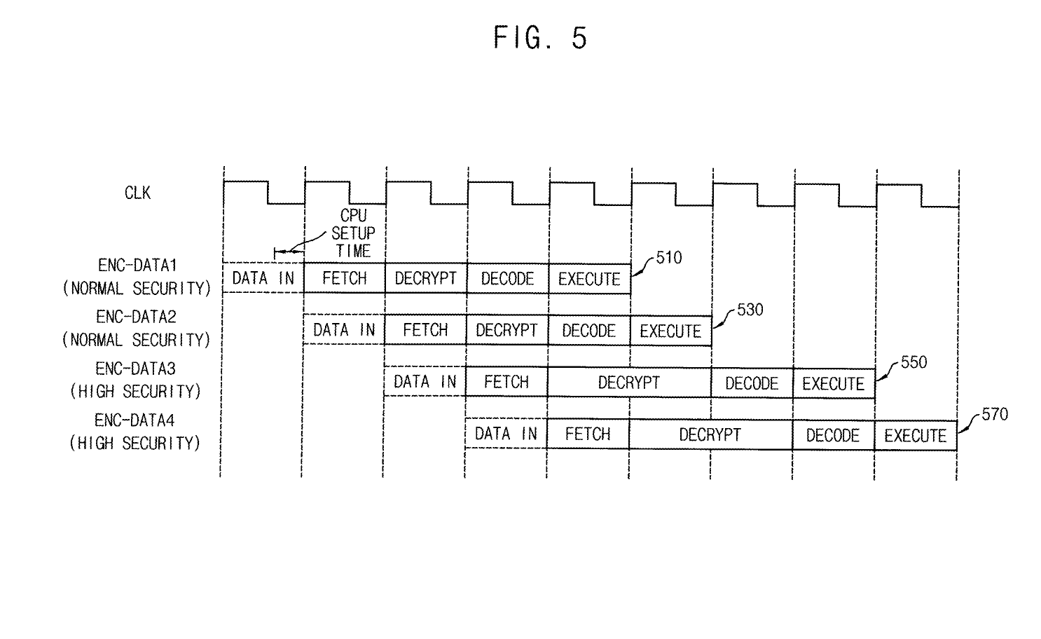

FIG. 4 is a block diagram illustrating a processor according to at least some example embodiments of the inventive concepts, and FIG. 5 is a timing diagram illustrating execution cycles of a processor of FIG. 4.

Referring to FIG. 4, a processor 400 includes a variable pipeline 410 and a security level determining unit 450. The variable pipeline 410 and security level determining unit 450 may be implemented, for example, by one or more circuits included in the processor 400. The processor 400 of FIG. 4 may have a similar configuration to a processor 200 of FIG. 2, except that a variable decryption block 420 is disposed between a fetch block 430 and a decode block 432.

The security level determining unit 450 may determine a security level of encrypted data ENC-DATA to be processed by the processor 400. The security level determining unit 450 may include a security policy storing unit 460, and a pipeline control unit 480. At least one security policy record 470 for the encrypted data ENC-DATA may be stored in the security policy storing unit 460. For example, the security policy record 470 may include an address range 472, the number of clock cycles 474 and an encryption key 476. The pipeline control unit 480 may receive an address ADDR of the encrypted data ENC-DATA, and may search the security policy storing unit 460 for the security policy record 470 including the address range 472 to which the received address ADDR belongs. The pipeline control unit 480 may provide the variable decryption block 420 included in the variable pipeline 410 with the number of clock cycles 474 and the encryption key 476 included in the searched security policy record 470.

The variable pipeline 410 may include the fetch block 430, the variable decryption block 420, the decode block 432 and the execute block 434. The fetch block 430 may fetch the encrypted data ENC-DATA from an external memory to store the encrypted data ENC-DATA in a register included in the processor 400. For example, the fetch block 430 may store the encrypted data ENC-DATA in an instruction register (IR). The variable decryption block 420 may generate original data by decrypting the encrypted data ENC-DATA stored in the register during the number of clock cycles corresponding to the security level of the encrypted data ENC-DATA (e.g., 0, 1, 2, or n clock cycles). For example, the variable decryption block 420 may perform the decryption operation during the number of clock cycles 474 indicated by a cycle number signal NCYC received from the pipeline control unit 480. Further, the variable decryption block 420 may perform the decryption operation using the encryption key KEY received from the pipeline control unit 480. The original data generated by the variable decryption block 420 may be stored in the instruction register or any other register. The decode block 432 may decode the original data, and the execute block 434 may execute the decoded original data.

The variable pipeline 410 may process in parallel the encrypted data ENC-DATA in a pipelined manner. FIG. 5 illustrates an example of the pipelined processing of the variable pipeline 410. In FIG. 5, 510 represents an execution timing of first encrypted data ENC-DATA1 having a normal security level, 530 represents an execution timing of second encrypted data ENC-DATA2 having the normal security level, 550 represents an execution timing of third encrypted data ENC-DATA3 having a high security level, and 570 represents an execution timing of fourth encrypted data ENC-DATA4 having the high security level.

As illustrated in FIG. 5, a fetch operation, a decryption operation, a decode operation and an execute operation may be sequentially performed with respect to each of the encrypted data ENC-DATA1, ENC-DATA2, ENC-DATA3 and ENC-DATA4. Respective stages of the variable pipeline 410, or the fetch block 430, the variable decryption block 420, the decode block 432 and the execute block 434 may process different data from among ENC-DATA1, ENC-DATA2, ENC-DATA3 and ENC-DATA4 in parallel, thereby improving the operating performance of the processor 400 and the system including the processor 400. Further, since the encryption/decryption operation as well as the fetch operation, the decode operation and the execute operation are performed in the pipelined manner, there may be little or no operating performance degradation resulting from the encryption/decryption. In addition, an operation time of the encryption/decryption operation may be adjusted according to the security level of the data. Accordingly, the encryption/decryption operation of the encryption/decryption algorithm that is suitable for the security level for each data can be performed.

As described above, since the processor 400 may perform the encryption/decryption operation inside of the processor 400, or at the variable decryption block 420, the original data may not be exposed outside of the processor 400, and may be securely protected. Further, the processor 400 according to at least some example embodiments of the inventive concepts may perform the encryption/decryption operation as well as the fetch operation, the decode operation and the execute operation in the pipelined manner, thereby reducing or preventing the operating performance degradation of the processor 400 and the system including the processor 400 associated with the encryption/decryption. In addition, the processor 400 according to at least some example embodiments of the inventive concepts may include the variable pipeline 410 that adjusts the operation time of the encryption/decryption operation according to the security level of the data to be processed. Accordingly, encryption/decryption operation having relatively strong encryption/decryption algorithm can be performed with respect to data that require the security of the high level, and data that require the security of the low level can be rapidly processed with a less strong encryption/decryption algorithm or no encryption/decryption.

Although FIGS. 2 and 4 illustrate examples of the variable pipelines including three stages (i.e., a fetch stage, a decode stage and an execute stage) except for the decryption block, according to at least some example embodiments of the inventive concepts, the variable pipeline of the processor may include any number of stages. Further, although FIGS. 2 and 4 illustrate examples where the processor includes one variable pipeline, in at least some example embodiments of the inventive concepts, the processor may include two or more variable pipelines. Although FIG. 2 illustrates an example where the variable decryption block 220 is disposed in front of the fetch block 230, and FIG. 4 illustrates an example where the variable decryption block 420 is disposed between the fetch block 430 and the decode block 432, according to at least some example embodiments of the inventive concepts, the variable decryption blocks 220 and 420 or at least one decryption block described below may be disposed at any position of the variable pipeline. Hereinafter, at least some example embodiments of the inventive concepts where at least one decryption block is disposed in front of the fetch block will be described.

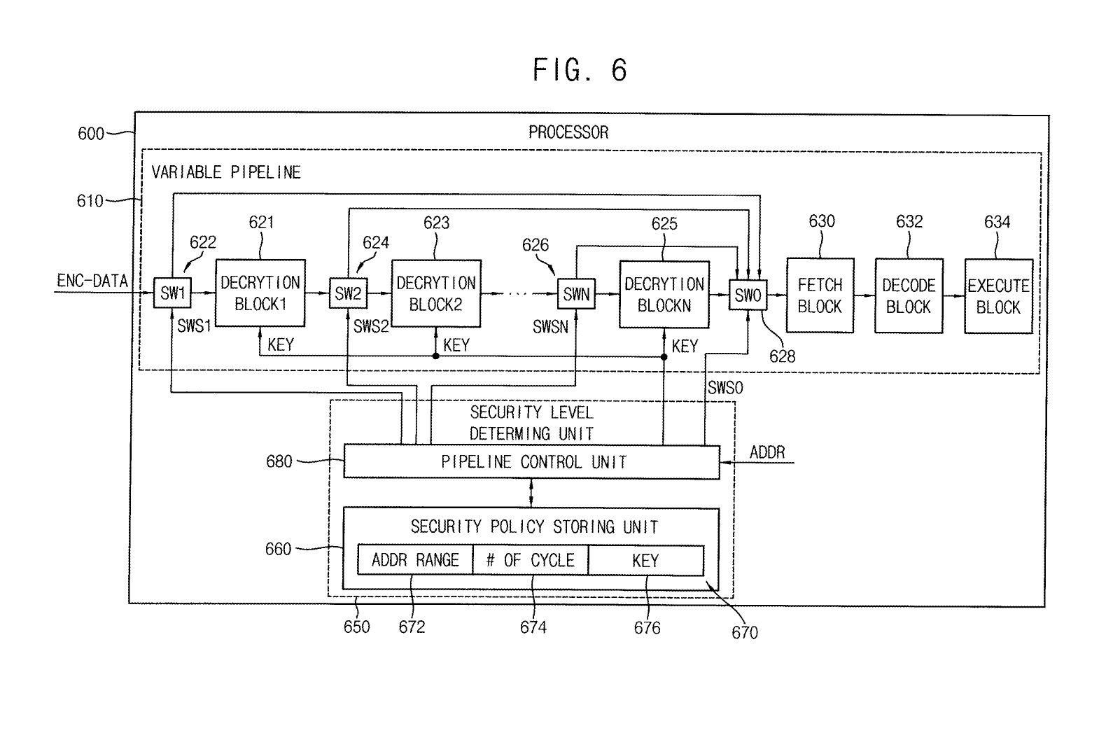

FIG. 6 is a block diagram illustrating a processor according to at least some example embodiments of the inventive concepts.

Referring to FIG. 6, a processor 600 includes a variable pipeline 610 and a security level determining unit 650. The variable pipeline 610 and security level determining unit 650 may be implemented, for example, by one or more circuits included in the processor 600. The processor 600 of FIG. 6 may have a similar configuration to a processor 200 of FIG. 2, except that the processor 600 includes a plurality of decryption blocks 621, 623 and 625 and a plurality of switches 622, 624, 626 and 628 instead of a variable decryption block 220.

The security level determining unit 650 may determine a security level of encrypted data ENC-DATA to be processed by the processor 600. The security level determining unit 650 may include a security policy storing unit 660, and a pipeline control unit 680. At least one security policy record 670 for the encrypted data ENC-DATA may be stored in the security policy storing unit 660. For example, the security policy record 670 may include an address range 672, the number of clock cycles 674 and an encryption key 676. The pipeline control unit 680 may receive an address ADDR of the encrypted data ENC-DATA, and may search the security policy storing unit 660 for the security policy record 670 including the address range 672 to which the received address ADDR belongs. The pipeline control unit 680 may generate a plurality of switching signals SWS1, SWS2, SWSN and SWS0 for controlling the plurality of switches 622, 624, 626 and 628 based on the number of clock cycles 674 included in the searched security policy record 670, and may provide the plurality of decryption blocks 621, 623 and 625 included in the variable pipeline 610 with the encryption key 676 included in the searched security policy record 670.

The variable pipeline 610 may include the plurality of decryption blocks 621, 623 and 625, which may be connected in series, the plurality of switches 622, 624 and 626 disposed at input terminals of the plurality of decryption blocks 621, 623 and 625, respectively, a fetch block 630, a decode block 632 and an execute block 634. Each decryption block 621, 623 and 625 may perform a decryption operation during one clock cycle. Each switch 622, 624 and 626 may selectively connect a data path to a corresponding one of the plurality of decryption blocks 621, 623 and 625 or to a next stage block (i.e., the fetch block 630). For example, a first switch 622 may selectively connect the data path to a first decryption block 621 or the fetch block 630 in response to a first switching signal SWS1, a second switch 624 may selectively connect the data path to a second decryption block 623 or the fetch block 630 in response to a second switching signal SWS2, and an N-th switch 626 may selectively connect the data path to an N-th decryption block 625 or the fetch block 630 in response to an N-th switching signal SWSN. In at least some example embodiments of the inventive concepts, the variable pipeline 610 may further include a switch 628 coupled to an input terminal of the fetch block 630. The switch 628 may connect one of a plurality of data paths to the fetch block 630 in response to a switching signal SWS0.

The pipeline control unit 680 may generate the switching signals SWS1, SWS2 and SWSN to control the switches 622, 624 and 626 such that a number of switches corresponding to the number of clock cycles 674 connect the data path to the corresponding decryption blocks and the remaining switches connect the data path to the fetch block 430.

For example, in a case where the number of clock cycles 674 corresponding to the address range 672 to which the address ADDR of the encrypted data ENC-DATA belongs is one, the pipeline control unit 680 may generate the first switching signal SWS1 having a first logic level and remaining switching signals SWS2 and SWSN having a second logic level. The first switch 622 may connect the data path of the encrypted data ENC-DATA to the first decryption block 621 in response to the first switching signal SWS1 having the first logic level, and the remaining switches 624 and 626 (or the next second switch 624) may connect the data path to the fetch block 630 in response to the switching signals SWS2 and SWSN having the second logic level. Thus, a decryption operation of one clock cycle may be performed on the encrypted data ENC-DATA by the first decryption block 621 to generate original data. The first decryption block 621 may perform the decryption operation by using the encryption key KEY provided from the pipeline control unit 680. In another example, in a case where the number of clock cycles 674 is two, the first and second switching signals SWS1 and SWS2 may have the first logic level, and the remaining switching signals SWSN may have the second logic level. Thus, a decryption operation of two clock cycles may be performed on the encrypted data ENC-DATA by the first and second decryption blocks 621 and 623 to generate original data. For example, each of the first and second decryption blocks 621 and 623 may perform a one-cycle decryption operation, and the two decryption operations may be performed in series resulting in a total decryption time of two clock cycles. The first and second decryption blocks 621 and 623 may perform the decryption operation by using the encryption key KEY provided from the pipeline control unit 680.

The fetch block 630 may store the original data in a register included in the processor 600. The decode block 632 may decode the original data, and the execute block 634 may execute the decoded original data.

As described above, since the processor 600 may perform the encryption/decryption operation inside of the processor 600, for example, using the plurality of decryption blocks 621, 623 and 625 that are connected in series, the original data may not be exposed outside of the processor 600, and may be securely protected. Further, the processor 600 according to at least some example embodiments of the inventive concepts may perform the encryption/decryption operation as well as the fetch operation, the decode operation and the execute operation in the pipelined manner, thereby reducing or preventing the operating performance degradation of the processor 600 and the system including the processor 600 associated with the encryption/decryption. In addition, the processor 600 according to at least some example embodiments of the inventive concepts may include the variable pipeline 610 that adjusts the operation time of the encryption/decryption operation according to the security level of the data to be processed. Accordingly, the encryption/decryption operation having the strong encryption/decryption algorithm can be performed with respect to data that require the security of the high level, and data that require the security of the low level can be rapidly processed.

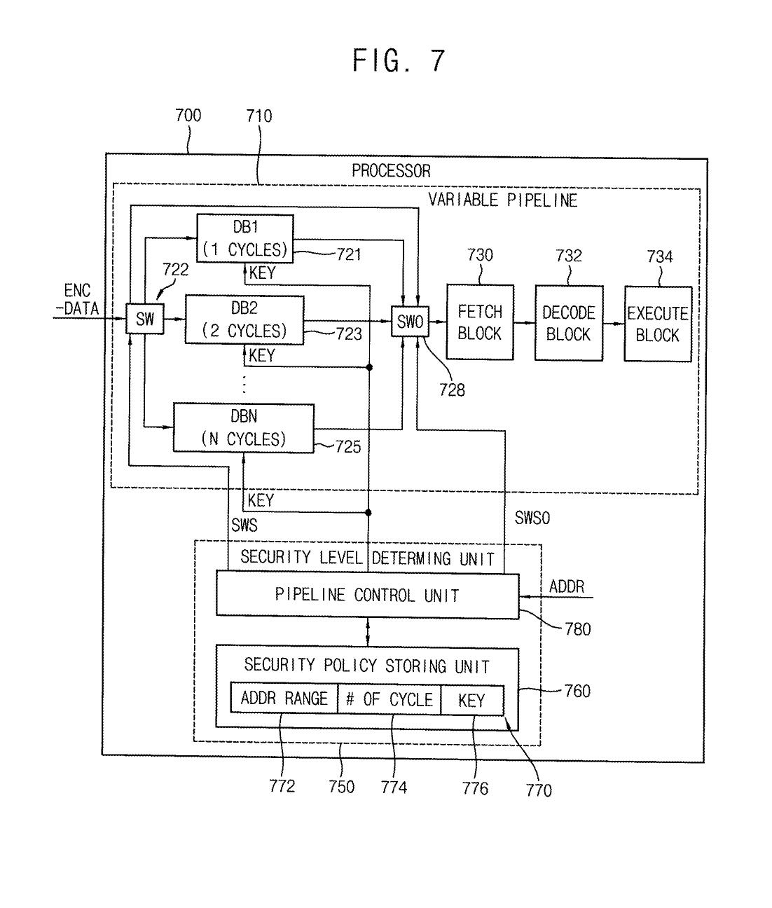

FIG. 7 is a block diagram illustrating a processor according to at least some example embodiments of the inventive concepts.

Referring to FIG. 7, a processor 700 includes a variable pipeline 710 and a security level determining unit 750. The variable pipeline 710 and security level determining unit 750 may be implemented, for example, by one or more circuits included in the processor 700. The processor 700 of FIG. 7 may have a configuration similar to that of the processor 200 of FIG. 2, except that the processor 700 includes, instead of a variable decryption block 220, a plurality of decryption blocks 721, 723 and 725 having different operation times and at least switches 722 and 728.

The security level determining unit 750 may determine a security level of encrypted data ENC-DATA to be processed by the processor 700. The security level determining unit 750 may include a security policy storing unit 760, and a pipeline control unit 780. At least one security policy record 770 for the encrypted data ENC-DATA may be stored in the security policy storing unit 760. For example, the security policy record 770 may include an address range 772, the number of clock cycles 774 and an encryption key 776. The pipeline control unit 780 may receive an address ADDR of the encrypted data ENC-DATA, and may search the security policy storing unit 760 for the security policy record 770 including the address range 772 to which the received address ADDR belongs. The pipeline control unit 780 may generate a switching signal SWS for controlling the switch 722 based on the number of clock cycles 774 included in the searched security policy record 770, and may provide the plurality of decryption blocks 721, 723 and 725 included in the variable pipeline 710 with the encryption key 776 included in the searched security policy record 770.

The variable pipeline 710 may include the plurality of decryption blocks 721, 723 and 725 having different operation times from each other, the switch 722, a fetch block 730, a decode block 732 and an execute block 734. The decryption blocks 721, 723 and 725 may perform decryption operations during different operation times. For example, a first decryption block 721 may perform the decryption operation during one clock cycle, a second decryption block 723 may perform the decryption operation during two clock cycles, and an N-th decryption block 725 may perform the decryption operation during N clock cycles. The switch 722 may connect a data path of the encrypted data ENC-DATA to one of the decryption blocks 721, 723 and 725 or to a next stage block (e.g., the fetch block 730) in response to the switching signal SWS. In at least some example embodiments of the inventive concepts, the variable pipeline 710 may further include a switch 728 coupled to an input terminal of the fetch block 730. The switch 728 may connect one of a plurality of data paths to the fetch block 730 in response to a switching signal SWS0.

The pipeline control unit 780 may generate the switching signal SWS to control the switch 722 to connect the data path to the fetch block 730 or to one of the decryption blocks 721, 723 and 725 having an operation time corresponding to the number of clock cycles 774.

For example, in a case where the number of clock cycles 774 corresponding to the address range 772 to which the address ADDR of the encrypted data ENC-DATA belongs is one, the pipeline control unit 780 may generate the switching signal SWS such that the data path of the encrypted data ENC-DATA is connected to the first decryption block 721 that performs the decryption operation during one clock cycle. Thus, a decryption operation of one clock cycle may be performed on the encrypted data ENC-DATA by the first decryption block 721 to generate original data. The first decryption block 721 may perform the decryption operation by using the encryption key KEY provided from the pipeline control unit 780. In another example, in a case where the number of clock cycles 774 is two, the pipeline control unit 780 may generate the switching signal SWS such that the data path of the encrypted data ENC-DATA is connected to the second decryption block 723 that performs the decryption operation during two clock cycles. Thus, a decryption operation of two clock cycles may be performed on the encrypted data ENC-DATA by the second decryption block 723 to generate original data. In another example, in a case where the number of clock cycles 774 is zero, the pipeline control unit 780 may generate the switching signal SWS such that the data path of the encrypted data ENC-DATA is connected directly to the fetch block 730 without a decryption operation being performed.

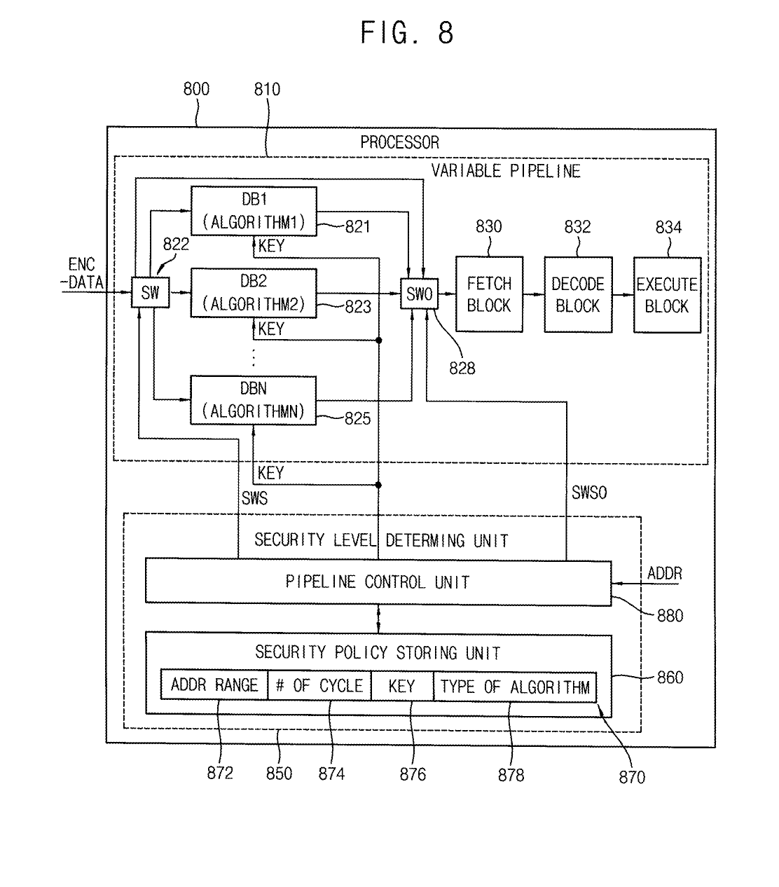

FIG. 8 is a block diagram illustrating a processor according to at least some example embodiments of the inventive concepts.

Referring to FIG. 8, a processor 800 includes a variable pipeline 810 and a security level determining unit 850. The variable pipeline 810 and security level determining unit 850 may be implemented, for example, by one or more circuits included in the processor 800. The processor 800 of FIG. 8 may have a similar configuration to a processor 200 of FIG. 2, except that the processor 800 includes a plurality of decryption blocks 821, 823 and 825 that perform decryption operations with different decryption algorithms and at least one switch 822 and 828 instead of a variable decryption block 220.

The security level determining unit 850 may determine a security level of encrypted data ENC-DATA to be processed by the processor 800. The security level determining unit 850 may include a security policy storing unit 860, and a pipeline control unit 880. At least one security policy record 870 for the encrypted data ENC-DATA may be stored in the security policy storing unit 860. For example, the security policy record 870 may include an address range 872, the number of clock cycles 874, an encryption key 876 and a type of algorithm 878 representing a type of encryption/decryption algorithm to be performed. The pipeline control unit 880 may receive an address ADDR of the encrypted data ENC-DATA, and may search the security policy storing unit 860 for the security policy record 870 including the address range 872 to which the received address ADDR belongs. The pipeline control unit 880 may generate a switching signal SWS for controlling the switch 822 based on the type of algorithm 878 and/or the number of clock cycles 874 included in the searched security policy record 870, and may provide the plurality of decryption blocks 821, 823 and 825 included in the variable pipeline 810 with the encryption key 876 included in the searched security policy record 870.

The variable pipeline 810 may include the plurality of decryption blocks 821, 823 and 825, the switch 822, a fetch block 830, a decode block 832 and an execute block 834. The decryption blocks 821, 823 and 825 may perform decryption operations with different decryption algorithms from each other. For example, a first decryption block 821 may perform the decryption operation with a first decryption algorithm, a second decryption block 823 may perform the decryption operation with a second decryption algorithm, and an N-th decryption block 825 may perform the decryption operation with an N-th decryption algorithm. The switch 822 may connect a data path of the encrypted data ENC-DATA to one of the decryption blocks 821, 823 and 825 or to a next stage block (e.g., the fetch block 830) in response to the switching signal SWS. In at least some example embodiments of the inventive concepts, the variable pipeline 810 may further include a switch 828 coupled to an input terminal of the fetch block 830. The switch 828 may connect one of a plurality of data paths to the fetch block 830 in response to a switching signal SWS0.

The pipeline control unit 880 may generate the switching signal SWS to control the switch 822 to connect the data path to one of the decryption blocks 821, 823 and 825 having a decryption algorithm indicated by the type of algorithm 878.

For example, in a case where the type of algorithm 878 corresponding to the address range 872 to which the address ADDR of the encrypted data ENC-DATA belongs indicates the first decryption algorithm, the pipeline control unit 880 may generate the switching signal SWS such that the data path of the encrypted data ENC-DATA is connected to the first decryption block 821 that performs the decryption operation with the first decryption algorithm. Thus, a decryption operation the first decryption algorithm may be performed on the encrypted data ENC-DATA by the first decryption block 821 to generate original data. The first decryption block 821 may perform the decryption operation by using the encryption key KEY provided from the pipeline control unit 880. In another example, in a case where the type of algorithm 878 indicates the second decryption algorithm, the pipeline control unit 880 may generate the switching signal SWS such that the data path of the encrypted data ENC-DATA is connected to the second decryption block 823 that performs the decryption operation with the second decryption algorithm. Thus, a decryption operation of the second decryption algorithm may be performed on the encrypted data ENC-DATA by the second decryption block 823 to generate original data. In another example, in a case where the type of algorithm 878 indicates no decryption is to be performed, the pipeline control unit 880 may generate the switching signal SWS such that the data path of the encrypted data ENC-DATA is connected directly to the fetch block 830 without a decryption operation being performed.

Although FIG. 8 illustrates an example where the decryption blocks 821, 823 and 825 have different decryption algorithms from each other, in at least some example embodiments of the inventive concepts, two or more decryption blocks of the plurality of decryption blocks 821, 823 and 825 may have the same decryption algorithm, and the two or more decryption blocks having the same decryption algorithm may have different operation times with respect to each other. In this case, the pipeline control unit 880 may generate the switching signal SWS such that an appropriate decryption block is selected based on the type of algorithm 878 and the number of clock cycles 874.

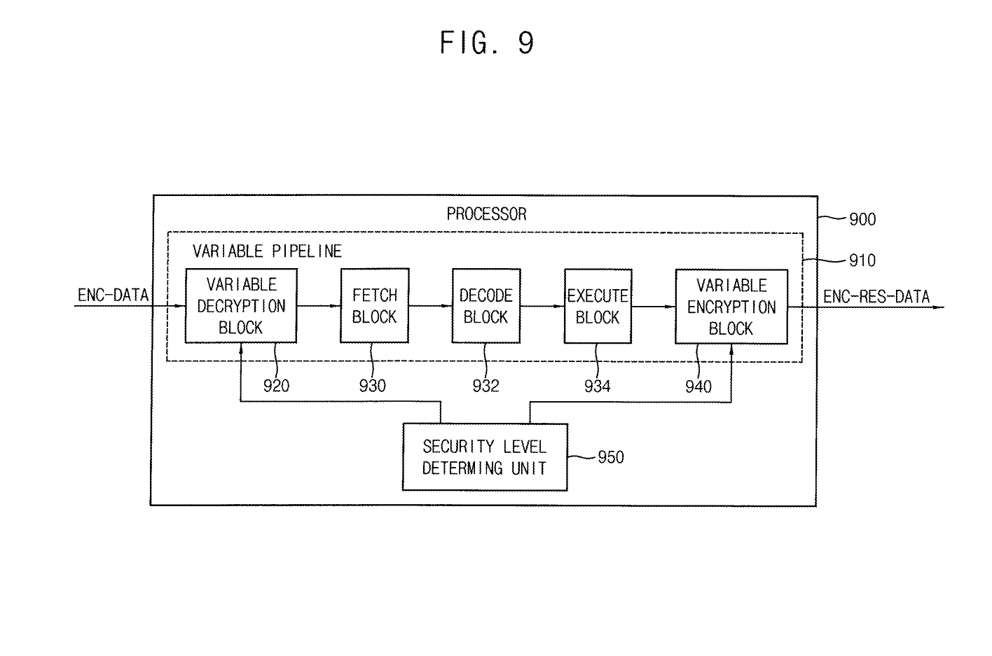

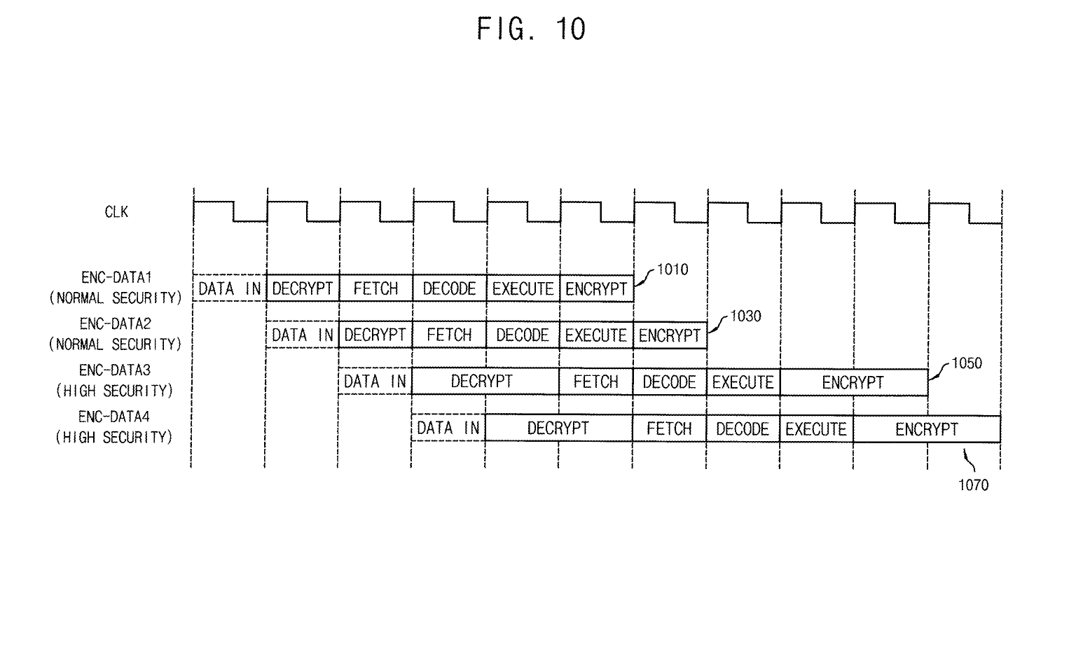

FIG. 9 is a block diagram illustrating a processor according to at least some example embodiments of the inventive concepts, and FIG. 10 is a timing diagram illustrating execution cycles of a processor of FIG. 9.

Referring to FIG. 9, a processor 900 includes a variable pipeline 910 and a security level determining unit 950. The variable pipeline 910 and security level determining unit 950 may be implemented, for example, by one or more circuits included in the processor 900. The processor 900 of FIG. 9 may have a configuration similar to that of the processor 200 of FIG. 2, except that the processor 900 further includes a second variable encryption block 940 in addition to a first variable encryption block 920.

The security level determining unit 950 may determine a security level of encrypted data ENC-DATA to be processed by the processor 900, and may control a first variable decryption block 920 and a second variable encryption block 940 included in the variable pipeline 910 to perform a decryption operation and an encryption operation during a number of clock cycles corresponding to the determined security level (e.g., 0, 1, 2, or n clock cycles).

The variable pipeline 910 may include the first variable decryption block 920, a fetch block 930, a decode block 932, an execute block 934 and the second variable encryption block 940. The first variable decryption block 920 may generate original data by decrypting the encrypted data ENC-DATA during the clock cycle corresponding to the determined security level. The fetch block 930 may store the original data in a register, the decode block 932 may decode the original data stored in the register, and the execute block 934 may process the decoded original data.

When a result of processing the original data by the execute block 934 is to be stored in an external memory, the second variable encryption block 940 may encrypt the result of processing the original data during the number of clock cycles corresponding to the security level determined by the security level determining unit 950 (e.g., 0, 1, 2, or n clock cycles), and may output encrypted result data ENC-RES-DATA to the outside. In at least some example embodiments of the inventive concepts, the security level determining unit 950 may control the second variable encryption block 940 based on the security level of the encrypted data ENC-DATA. In other at least some example embodiments of the inventive concepts, the security level determining unit 950 may control the second variable encryption block 940 based on a security level of the encrypted result data ENC-RES-DATA to be stored in the external memory. For example, the security level determining unit 950 may search for an address range to which an address of the encrypted result data ENC-RES-DATA belongs, and may control the second variable encryption block 940 to perform the encryption operation during the clock cycle corresponding to the searched address range.

The variable pipeline 910 may process in parallel the encrypted data ENC-DATA in a pipelined manner. FIG. 10 illustrates an example of the pipelined processing of the variable pipeline 910. In FIG. 10, 1010 represents an execution timing of first encrypted data ENC-DATA1 having a normal security level, 1030 represents an execution timing of second encrypted data ENC-DATA2 having the normal security level, 1050 represents an execution timing of third encrypted data ENC-DATA3 having a high security level, and 1070 represents an execution timing of fourth encrypted data ENC-DATA4 having the high security level.

As illustrated in FIG. 10, a decryption operation, a fetch operation, a decode operation, an execute operation and an encryption operation may be sequentially performed with respect to each encrypted data ENC-DATA1, ENC-DATA2, ENC-DATA3 and ENC-DATA4. Respective stages of the variable pipeline 910, or the variable decryption block 920, the fetch block 930, the decode block 932, the execute block 934 and the variable encryption block 940 may process different data ENC-DATA1, ENC-DATA2, ENC-DATA3 and ENC-DATA4 in parallel, thereby improving the operating performance of the processor 900 and the system including the processor 900. Further, since the encryption/decryption operation as well as the fetch operation, the decode operation and the execute operation are performed in the pipelined manner, there may be little or no operating performance degradation resulting from the associated with the encryption/decryption. In addition, an operation time of the encryption/decryption operation may be adjusted according to the security level of the data. Accordingly, the encryption/decryption operation of the encryption/decryption algorithm that is suitable for the security level for each data can be performed.

As described above, since the processor 900 may perform the decryption operation and the encryption operation inside of the processor 900, or at the first and second variable decryption block 920 and 940, the original data may not be exposed outside of the processor 900, and may be securely protected. Further, the processor 900 according to at least some example embodiments of the inventive concepts may perform the encryption and decryption operations as well as the fetch operation, the decode operation and the execute operation in the pipelined manner, thereby reducing or preventing the operating performance degradation of the processor 900 and the system including the processor 900 associated with the encryption/decryption. In addition, the processor 900 according to at least some example embodiments of the inventive concepts may include the variable pipeline 910 that adjusts the operation time of the encryption/decryption operation according to the security level of the data to be processed. Accordingly, the encryption/decryption operation having the strong encryption/decryption algorithm can be performed with respect to data that require the security of the high level, and data that require the security of the low level can be rapidly processed.

Although FIG. 9 illustrates an example where the second variable encryption block 940 is disposed next to the execute block 934, according to at least some example embodiments of the inventive concepts, the second variable encryption block 940 may be disposed at any position of the variable pipeline 910. In at least some example embodiments of the inventive concepts, the processor 900 may include, along with or instead of the second variable encryption block 940, a plurality of encryption blocks that are connected in series, a plurality of encryption blocks having different operation times, or a plurality of encryption blocks having different encryption algorithms.

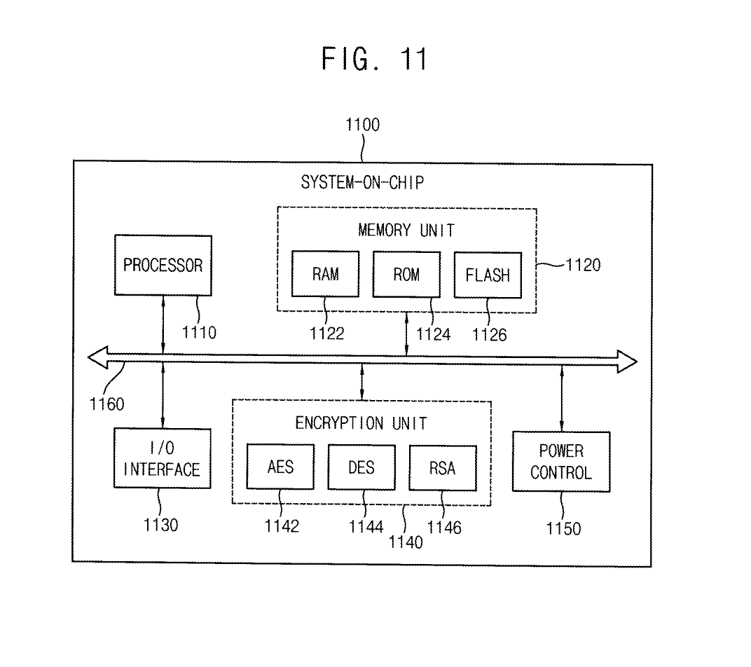

FIG. 11 is a block diagram illustrating a system-on-chip according to at least some example embodiments of the inventive concepts.

Referring to FIG. 11, a system-on-chip 1100 may include a processor 1110 and a memory unit 1120. In at least some example embodiments of the inventive concepts, the system-on-chip 1100 may further include an input/output interface 1130, an encryption unit 1140, a power control unit 1150 and a bus 1160. According to at least some example embodiments of the inventive concepts, the system-on-chip 1100 may be a smart card chip, a trusted platform module (TPM) chip, an application processor (AP), or the like.

The processor 1110 may control an overall operation of the system-on-chip 1100. For example, the processor 1110 may control operations of the memory unit 1120, the input/output interface 1130, the encryption unit 1140 and the power control unit 1150. The processor 1110 may fetch encrypted data (e.g., encrypted program data or encrypted normal data), and may process the fetched data. In at least some example embodiments of the inventive concepts, the processor 1110 may be a central processing unit (CPU) or a microprocessor. The processor 1110 may be coupled to the memory unit 1120 via the bus 1160.

The memory unit 1120 stored the encrypted data. In at least some example embodiments of the inventive concepts, the memory unit 1120 may include a volatile memory, such as a random access memory (RAM) 1122, and/or a nonvolatile memory, such as a read only memory (ROM) 1124, a flash memory 1126, or the like. The random access memory 1122 may serve as a working memory for the processor 1110. For example, the random access memory 1122 may be implemented with a dynamic random access memory (DRAM), a static random access memory (SRAM), or the like. The read only memory 1124 and/or the flash memory 1126 may store a boot image, or may store security data, such as a cryptographic key, sensitive data, a sensitive code, etc., and/or normal data.

The input/output interface 1130 may be coupled to an external device, and the processor 1110 may communicate with the external device via the input/output interface 1130. For example, the input/output interface 1130 may have at least one of various interface protocols, such as USB (Universal Serial Bus), MMC (Multi-Media Card), PCI-E (Peripheral Component Interconnect-Express), SAS (Serial-attached SCSI), SATA (Serial Advanced Technology Attachment), PATA (Parallel Advanced Technology Attachment), SCSI (Small Computer System Interface), ESDI (Enhanced Small Disk Interface), IDE (Integrated Drive Electronics), etc.

The encryption unit 1140 may perform an encryption/decryption operation in response to a request from the external device via the input/output interface 1130. The encryption unit 1140 may include an AES (Advanced Encryption Standard) unit 1142, a DES (Data Encryption Standard) unit 1144, an RSA (Rivest Shamir Adleman) unit 1146, etc. The power control unit 1150 may control and manage the power of the system-on-chip 1100.

Data may be encrypted before being stored in the memory unit 1120, and the processor 1110 may receive the encrypted data from the memory unit 1120. The processor 1110 may generate original data by decrypting the encrypted data during a clock cycle corresponding to a security level of the encrypted data, and may process the original data. Since the encryption/decryption operation for the data is performed inside the processor 1110, the original data may not be exposed to the outside, and may be securely protected. Further, the processor 1110 may perform the encryption/decryption operation in a pipelined manner, thereby reducing or preventing the operating performance degradation of the processor 1110 and the system-on-chip 1100 associated with the encryption/decryption. In addition, the processor 1110 may include a variable pipeline that adjusts the operation time of the encryption/decryption operation according to the security level of the data to be processed. Accordingly, the encryption/decryption operation having the strong encryption/decryption algorithm can be performed with respect to data that require the security of the high level, and data that require the security of the low level can be rapidly processed. For example, according to at least some example embodiments of the inventive concepts, the processor 1110 may have the same structure and/or operation as that described above with respect to any of processors 100, 200, 400, 600, 700, 800, and 900 in FIGS. 1-10.

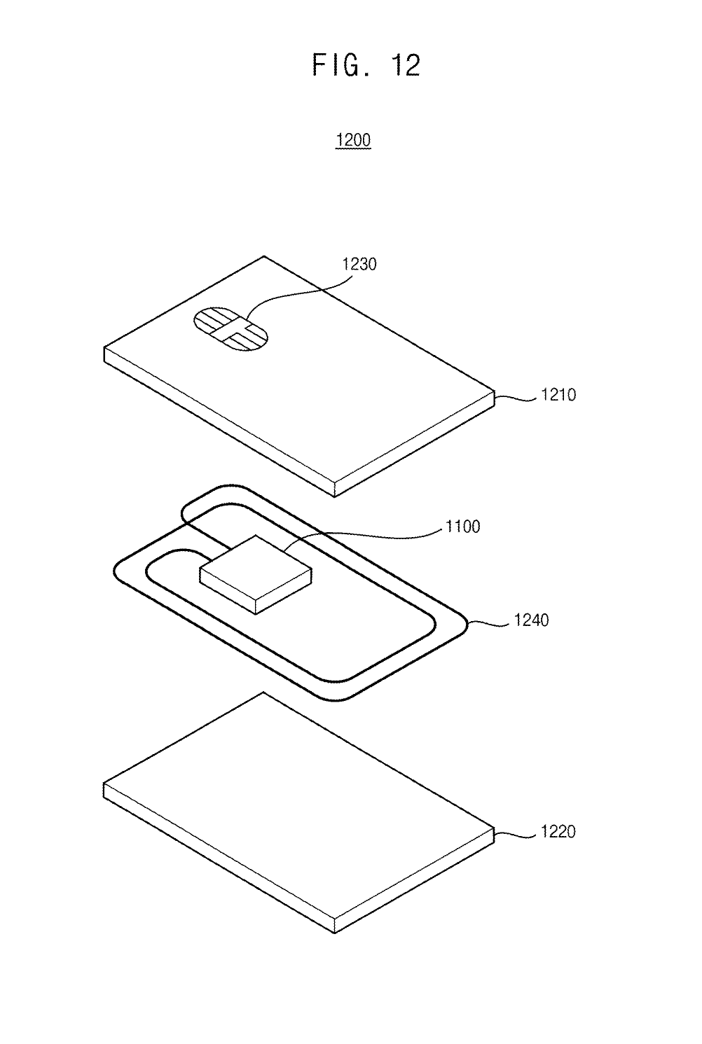

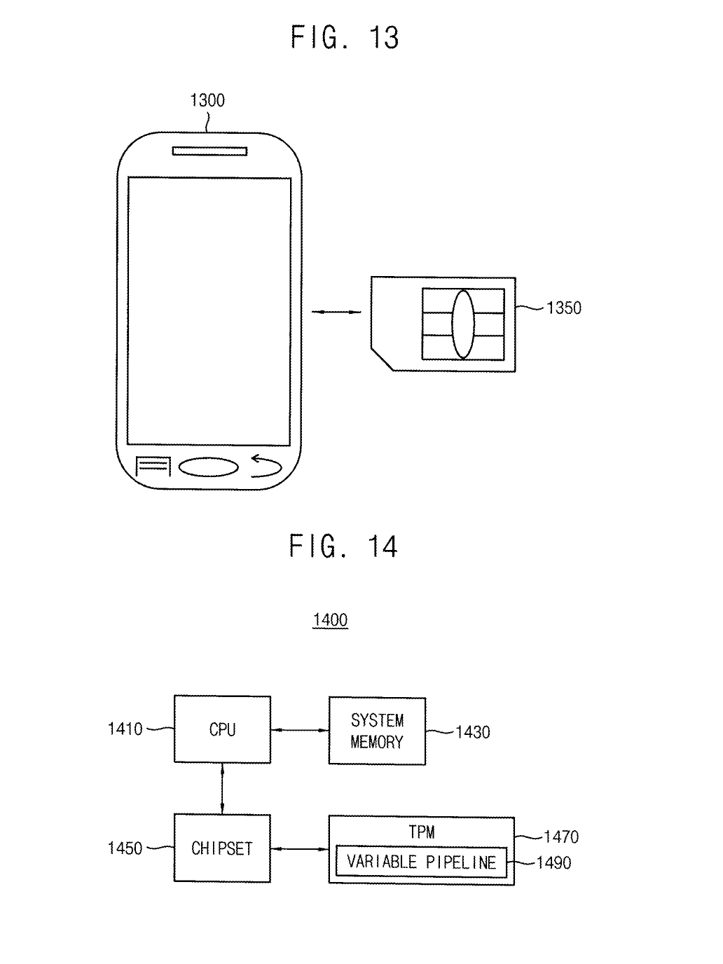

FIGS. 12 and 13 are diagrams illustrating an example where a system-on-chip according to at least some example embodiments of the inventive concepts is employed in a smart card.

FIG. 12 is an exploded perspective view illustrating a smart card 1200 including the system-on-chip 1100 illustrated in FIG. 11. Referring to FIG. 12, a smart card 1200 includes a system-on-chip 1100, first and second base members 1210 and 1220, a contact unit 1230 and an antenna 1240.

The first and second base members 1210 and 1220 may be formed of a plastic, or the like. The system-on-chip 1100 may be formed between the first and second base members 1210 and 1220. The system-on-chip 1100 may be a smart card chip included in the smart card 1200. The contact unit 1230 including a plurality of pins may be formed in the first base member 1210. The contact unit 1230 may provide an interface to transfer data by being coupled to an external device (not shown), such as a card terminal. For example, the contact unit 1230 may comply with an international standardization organization (ISO) 7816 standard. The antenna 1240 may be formed as a coil between the first and second base members 1210 and 1220. The antenna 1240 may transmit/receive a wireless signal of a predetermined frequency. For example, the antenna 1240 may comply with an ISO 14443 standard.

As is explained above with reference to FIG. 11, a processor included in the system-on-chip 1100 may perform an encryption/decryption operation at the inside of the processor, and thus original data may not be exposed to the outside. Further, the processor included in the system-on-chip 1100 may perform the encryption/decryption operation in a pipelined manner, thereby reducing or preventing the operating performance degradation of the processor and the system-on-chip 1100 associated with the encryption/decryption. In addition, the processor included in the system-on-chip 1100 may include a variable pipeline that adjusts the operation time of the encryption/decryption operation according to the security level of the data to be processed. Accordingly, the encryption/decryption operation having the strong encryption/decryption algorithm can be performed with respect to data that require the security of the high level, and data that require the security of the low level can be rapidly processed.

The smart card 1200 may be a hybrid card including an integrated circuit with a contact interface and an integrated circuit with a contactless interface. Although FIG. 12 illustrates an example of a combination (combo) card (i.e., a dual-interface card) including both of the contact unit 1230 and the antenna 1240, it is possible that the smart card 1200 may include one of the contact interface and the contactless interface.

In an example illustrated in FIG. 13, a card 1350 including a system-on-chip according to at least some example embodiments of the inventive concepts may be a subscriber identity module (SIM) card 1350 that is detachably attached to a mobile device 1300. For example, according to at least one example embodiment, the SIM card 1350 may include the system-on-chip 1100 discussed above with reference to FIG. 11.

In at least some example embodiments of the inventive concepts, a card including a system-on-chip according to at least some example embodiments of the inventive concepts may include a smart card, a multimedia card (MMC), an embedded multimedia card (eMMC), a hybrid embedded multimedia card (hybrid eMMC), a secure digital (SD) card, a micro SD card, a memory stick, an ID card, a personal computer memory card international association (PCMCIA) card, a chip card, a USB card, a compact flash (CF) card, or the like.

According to at least some example embodiments of the inventive concepts, the mobile device 1300 may be or include, for example, one or more of a cellular phone, a smart phone, a tablet PC, a laptop computer, a personal digital assistant (PDA), a portable multimedia player (PMP), a digital camera, a music player, a portable game console, a navigation system, or the like.

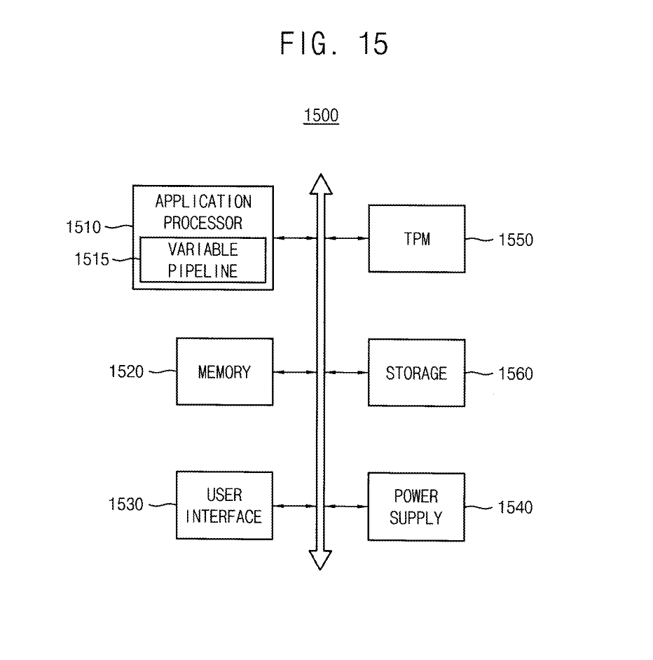

FIG. 14 is a diagram illustrating an example where a system-on-chip according to at least some example embodiments of the inventive concepts is employed in a trusted platform module (TPM).

Referring to FIG. 14, a computing system 1400 may include a CPU 1410, a system memory 1430, a chipset 1450 and a trusted platform module (TPM) 1470. According to at least some example embodiments of the inventive concepts, the computing system 1400 may be any computing system, such as a personal computer (PC), a server computer, a workstation, a laptop computer, a cellular phone, a smart phone, a personal digital assistant (PDA), a portable multimedia player (PMP), a digital camera, a digital television, a set-top box, a music player, a portable game console, a navigation system, or the like.

The CPU 1410 may be mounted on a board, such as a motherboard or a main board, and may perform calculations or tasks. The CPU 1410 may include a memory controller that controls an operation of the system memory 1430. The system memory 1430 may store data processed by the CPU 1410. The CPU 1410 may be coupled to the chipset 1450. The chipset 1450 may provide interfaces with peripheral devices. The chipset 1450 may include input/output hub and an input/output controller hub.

The TPM 1470 may be mounted on a board, such as a motherboard or a main board, and may be coupled to the chipset 1450 via a serial peripheral interface (SPI) bus or a peripheral component interconnect express (PCIe) bus. The TPM 1470 may provide security functions, such as data encryption/decryption, hashing, random number generation, cryptographic key generation, etc.

A processor included in the TPM 1470 may perform an encryption/decryption operation at the inside of the processor, and thus original data may not be exposed to the outside. Further, the processor included in the TPM 1470 may perform the encryption/decryption operation in a pipelined manner, thereby reducing or preventing the operating performance degradation of the processor and the TPM 1470 associated with the encryption/decryption. In addition, the processor included in the TPM 1470 may include a variable pipeline that adjusts the operation time of the encryption/decryption operation according to the security level of the data to be processed. Accordingly, the encryption/decryption operation having the strong encryption/decryption algorithm can be performed with respect to data that require the security of the high level, and data that require the security of the low level can be rapidly processed.

FIG. 15 is a diagram illustrating an example where a system-on-chip according to at least some example embodiments of the inventive concepts is employed in an application processor (AP).

Referring to FIG. 15, a mobile device 1500 includes an application processor 1510, a memory 1520, a user interface 1530, a power supply 1540, a TPM 1550 and a storage device 1560. In at least some example embodiments of the inventive concepts, the mobile device 1500 may further include a modem, such as a baseband chipset, and an image processor. According to at least some example embodiments of the inventive concepts, the mobile device 1500 may be or include, for example, any mobile device, such as cellular phone, a smart phone, a tablet PC, a laptop computer, a personal digital assistant (PDA), a portable multimedia player (PMP), a digital camera, a music player, a portable game console, a navigation system, or the like.

The application processor 1510 may control an overall operation of the mobile device 1500. In at least some example embodiments of the inventive concepts, the application processor 1510 may execute applications, such as an internal browser, a game application, a video player, etc. The application processor 1510 may include a single processor core or multiple processor cores. For example, the application processor 1510 may be a multi-core processor, such as a dual-core processor, a quad-core processor, a hexa-core processor, or the like.

The application processor 1510 may be implemented as a system-on-chip. A processor included in the system-on-chip may perform an encryption/decryption operation inside of the processor, and thus original data may not be exposed outside of the processor. Further, the processor of the system-on-chip may include a variable pipeline 1515 having an encryption/decryption stage of which an operation time is adaptively adjusted. Accordingly, the processor of the system-on-chip may perform the strong encryption/decryption operation without the operating performance degradation.

The memory 1520 may store data required for operating the mobile device 1500. For example, the memory 1520 may store a boot image for booting the mobile device 1500, or may store data transmitted/received to/from an external device. For example, the memory 1520 may be implemented by a dynamic random access memory (DRAM), a static random access memory (SRAM), a mobile DRAM, DDR SDRAM, LPDDR SDRAM, GDDR SDRAM, RDRAM, a flash memory, a static random access memory (SRAM), a phase random access memory (PRAM), a ferroelectric random access memory (FRAM), a resistive random access memory (RRAM), a magnetic random access memory (MRAM), etc.

The user interface 1530 may include at least one input device, such as a keyboard, a mouse, a touch screen, etc., and at least one output device, a printer, a display device, etc. The power supply 1540 may supply the mobile device 1500 with power.

The TPM 1550 may provide security functions, such as data encryption/decryption, hashing, random number generation, cryptographic key generation, etc. A processor of the TPM 1550 may include a variable pipeline having an encryption/decryption stage of which an operation time is adaptively adjusted.

The storage device 1560 may include a memory card, a solid state drive (SSD), a hard disk drive (HDD), a CD-ROM, or the like. The storage device 1560 may be a smart card, and a processor of the smart card may include a variable pipeline having an encryption/decryption stage of which an operation time is adaptively adjusted.

In at least some example embodiments of the inventive concepts, components of the mobile device 1500 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

Example embodiments of the inventive concepts may be applied to any processor or a system-on-chip, such as a smart card chip, a trusted platform module chip, an application processor, etc.

The foregoing is illustrative of at least some example embodiments of the inventive concepts and is not to be construed as limiting thereof. Although a few at least some example embodiments of the inventive concepts have been described, those skilled in the art will readily appreciate that many modifications are possible in the at least some example embodiments of the inventive concepts without materially departing from the novel teachings and advantages of example embodiments of the inventive concepts. Accordingly, all such modifications are intended to be included within the scope of the present inventive concept as defined in the claims. Therefore, it is to be understood that the foregoing is illustrative of various at least some example embodiments of the inventive concepts and is not to be construed as limited to the specific at least some example embodiments of the inventive concepts disclosed, and that modifications to the disclosed at least some example embodiments of the inventive concepts, as well as other at least some example embodiments of the inventive concepts, are intended to be included within the scope of the appended claims.

What is claimed is:

1. A processor, comprising:
a security level determining unit configured to determine a security level of first data to be processed by the processor; and
a variable pipeline configured to receive the first data, to generate original data by performing a decryption operation on the first data during a total number of one or more clock cycles corresponding to the security level determined by the security level determining unit, and to process the original data.

2. The processor of claim 1, wherein the variable pipeline comprises:
a variable decryption block configured to adjust an operation time of the decryption operation according to the security level of the first data.

3. The processor of claim 2, wherein the processor is configured such that the variable decryption block,
does not perform the decryption operation when the security level of the first data is a low security level,
performs the decryption operation during one clock cycle when the security level of the first data is a normal security level, and
performs the decryption operation during two or more clock cycles when the security level of the first data is a high security level.

4. The processor of claim 1, wherein the variable pipeline comprises:
a variable decryption block configured to generate the original data by decrypting the first data during the one or more clock cycles corresponding to the security level;
a fetch block configured to store the original data in a register;
a decode block configured to decode the original data; and
an execute block configured to execute the decoded original data.

5. The processor of claim 1, wherein the variable pipeline comprises:
a fetch block configured to store the first data in a register;
a variable decryption block configured to generate the original data by decrypting the first data that are stored in the register during the one or more clock cycles corresponding to the security level;
a decode block configured to decode the original data; and
an execute block configured to execute the decoded original data.

6. The processor of claim 1, wherein the variable pipeline comprises:
a plurality of decryption blocks that are connected in series; and
a plurality of switches disposed at input terminals of the plurality of decryption blocks, respectively, each switch configured to selectively connect a data path to a corresponding one of the plurality of decryption blocks or to a next stage block, the next stage block being a block of the variable pipeline that follows the plurality of decryption blocks.

7. The processor of claim 6, wherein, among the plurality of switches, each of a number of switches corresponding to the total number of one or more clock cycles that is determined according to the security level of the first data connects the data path to the corresponding one of the plurality of decryption blocks, and remaining ones of the switches connect the data path to the next stage block.

8. The processor of claim 1, wherein the variable pipeline comprises:
a plurality of decryption blocks configured to respectively perform decryption operations during different operation times, the different operation times having differing durations; and
a switch configured to connect a data path to a decryption block having one of the different operation times corresponding to the clock cycle that is determined according to the security level of the first data among the plurality of decryption blocks.

9. The processor of claim 1, wherein the variable pipeline comprises:
a plurality of decryption blocks configured to respectively perform decryption operations with different decryption algorithms; and
a switch configured to connect a data path to a decryption block having a first decryption algorithm from among the plurality of decryption blocks, the first decryption algorithm being a decryption algorithm that corresponds to the security level of the first data from among the different decryption algorithms.

10. The processor of claim 1, wherein the processor is configured such that the variable pipeline encrypts a result of processing the original data during the clock cycle corresponding to the security level, and outputs the encrypted result.

11. The processor of claim 10, wherein the variable pipeline comprises:
a variable encryption block configured to adjust an operation time of an encryption operation according to the security level of the first data.

12. The processor of claim 1, wherein the security level determining unit comprises:
a security policy storing unit configured to store an address range for the first data, and a number of clock cycles corresponding to the address range; and
a pipeline control unit configured to receive an address of the first data to be processed by the processor, to read the number of clock cycles corresponding to the address range to which the received address belongs from the security policy storing unit, and to control the variable pipeline to perform the decryption operation during an operation time corresponding to the read number of clock cycles.

13. The processor of claim 12, wherein the processor is configured such that,
the security level determining unit further stores an encryption key corresponding to the address range, and
the pipeline control unit controls the variable pipeline to perform the decryption operation using the encryption key corresponding to the address range to which the received address belongs.

14. The processor of claim 12, wherein the processor is configured such that,
the security level determining unit further stores a type of a decryption algorithm corresponding to the address range, and
the pipeline control unit controls the variable pipeline to perform the decryption operation with the decryption algorithm corresponding to the address range to which the received address belongs.

15. A system-on-chip, comprising:
a memory unit configured to store first data; and
a processor configured to,
receive the first data from the memory unit, to determine a security level of the first data,
generate original data by performing a decryption operation on the first data during a clock cycle corresponding to the determined security level, and
process the original data.

16. A processor, comprising:
a security level determining unit configured to determine a security level of first data; and
a variable pipeline configured to,
receive the first data,
generate original data by performing a decryption operation on the first data, and
process the original data,
the processor being configured to select the duration of the decryption operation based on the determined security level.

17. The processor of claim 16,
wherein the security level determined by the security level determining unit is selected from among a plurality of different security levels, the plurality of security levels including a lowest security level and a plurality of upper security levels,
wherein the processor is configured such that the duration selected by the processor is one or more clock cycles when the determined security level is one of the higher security levels, and
wherein the processor is configured such that the variable pipeline does not perform the decryption operation when the determined security level is the lowest security level.

18. The processor of claim 17, wherein, the processor is configured such that, when the determined security level is one of the plurality of upper security levels, a total number of the clock cycles in the duration selected by the processor increases as the determined security level becomes higher, and the total number of the clock cycles in the duration selected by the processor decreases as the determined security level becomes lower.

19. The processor of claim 17, wherein,
the plurality of upper security levels each correspond to one of a plurality of different decryption algorithms,
wherein the plurality of upper security levels includes at least first and second security levels, the plurality of different decryption algorithms includes at least first and second decryption algorithms, and the first and second security levels correspond to the first and second decryption algorithms, respectively, and
wherein, when the determined security level is one of the plurality of upper security levels, the variable pipeline is configured to perform the decryption operation using a selected decryption algorithm, the selected decryption algorithm being the decryption algorithm, from among the plurality of algorithms, that corresponds to the determined security level.
